(19) United States
(12) Patent Application Publication
(10) Pub. No.: US 2011/0179870 A1
(43) Pub. Date: Jul. 28, 2011

(54) DUAL-AXIS ACCELERATION DETECTION ELEMENT

(76) Inventors: Chun-Kai CHAN, Hsinchu City (TW); Weileun Fang, Hsinchu City (TW)

(21) Appl. No.: 12/692,906

(22) Filed: Jan. 25, 2010

(51) Int. Cl. G01P 15/125

(52) U.S. Cl. 73/514.32

(57) ABSTRACT

A dual-axis acceleration detection element comprises a first detection element, a second detection element and a stationary unit. The first detection element is movable relative to the second detection element. The second detection element is movable relative to the stationary unit. The relative movements take place on different axes to detect acceleration on two different axes. The first detection element and the second detection element are interposed by corresponding detection electrodes, and the second detection element and the stationary unit also are interposed by other corresponding detection electrodes. Hence when the relative movements occur among the first and second detection elements and the stationary unit, overlapped areas of the detection electrodes change to generate and output a capacitance difference, thereby acceleration alteration can be detected.

### FIELD OF THE INVENTION

The present invention relates to a dual-axis acceleration detection element and particularly to a capacitive dual-axis acceleration detection element.

### BACKGROUND OF THE INVENTION

Micro-electromechanical system (MEMS in short) adopts semiconductor manufacturing process and other micro mechanical fabrication methods to fabricate and integrate various types of sensors, actuators, optical elements and the like. Through MEMS technique, elements can be miniaturized to achieve a lot of benefits such as lower cost, lower power loss, faster response speed and higher precision.

The conventional micro-sensor adopts a principle by transforming a targeted physical quantity to an electric signal through a sensing element, then analyzing the electric signal to get the targeted physical quantity indirectly. An acceleration sensor detects alterations of physical state caused by acceleration through a detection element to generate a corresponding electric signal such as voltage, resistance, inductance. It is widely used in applications such as vehicle safety detection, handsets, computers, electronic game machines and the like.

Frobenius made a detection element in 1972 through a cantilever structure of varying lengths. When the detection element is interfered by an external force the cantilever structure moves due to inertia to make a corresponding conductor to generate a signal to detect acceleration. Roylance made a piezoresistive micro-accelerator in 1979 by coupling a cantilever with a mass block and incorporating piezoresistive characteristics of silicon. Rudolf proposed in 1983 a capacitive micro-acceleration sensor that includes a mass block with a cantilever structure at two sides for support. When the mass block is subject to an external force and swings, the cantilever is driven and twisted to generate a capacitance alteration to get a corresponding electric signal.

The capacitive micro-acceleration sensor detects alteration of capacitance to derive acceleration. Compared with the conventional acceleration sensors that adopt piezoelectric, piezoresistive, and tunneling current, the capacitive acceleration sensor provides a higher sensitivity, lower temperature effect, lower electric power consumption, simpler structure and higher output. Hence a lot of efforts have been devoted to its research and applications. R.O.C. patent No. I284203 entitled “Accelerator” discloses a capacitive accelerator which comprises a stationary unit and a movable unit that contain respectively a plurality of detection electrodes arranged in an interdigitated fashion. When the movable unit is moved by an external force, the distance between the detection electrodes changes and results in alteration of capacitance. Thereby acceleration alteration can be detected.

According to capacitance equation of parallel electrode plates: C=∈A/d (where ∈ is dielectric coefficient, A is overlapped area of two electrode plates, and d is the distance between the two capacitor plates), capacitance alteration can be obtained by detection of distance (d) change. Alteration values of the capacitance and the distance alterations form a nonlinear relationship, hence estimate and operation of the acceleration are more difficult, and errors are prone to occur. Thus the present invention aims to provide a dual-axis acceleration detection device to get an improved linear relationship on acceleration by detecting capacitance alteration caused by area change.

### SUMMARY OF THE INVENTION

Therefore, the primary object of the present invention is to provide a dual-axis acceleration detection element that has a high sensitivity and improved linear relationship.

Another object of the present invention is to provide a dual-axis acceleration detection element to detect capacitance difference caused by alteration of electrode area to detect acceleration amount and direction.

To achieve the foregoing objects, the dual-axis acceleration detection element according to the present invention comprises a first detection element, a second detection element and a stationary unit. The first detection element is movable relative to the second detection element. The second detection element is movable relative to the stationary unit. The relative movements take place on different axes. Hence accelerations on two different axes can be detected. Furthermore, the first detection element and the second detection element are interposed by corresponding detection electrodes, and the second detection element and the stationary unit also are interposed by other corresponding detection electrodes. When a relative movement takes place among the first detection element, second detection element and stationary unit, the overlapped area of the detection electrodes changes, therefore a capacitance difference is generated and output. Thereby acceleration alteration can be detected.

In an embodiment of the present invention, the detection electrodes form an elevation difference between them and include an overlapped area to form differential capacitor detection electrodes.

The dual-axis acceleration detection element according to the present invention can be fabricated through a micro-electromechanical fabrication process at a smaller size and lower cost. It provides improved acceleration linear relationship, higher sensitivity, and smaller detection errors in non-detection axes.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the present invention.

FIG. 2A is a perspective view of an embodiment of the first detection element of the present invention.

FIG. 2B is a top view of an embodiment of the first detection element of the present invention.

FIG. 3A is a perspective view of an embodiment of the second detection element of the present invention.

FIG. 3B is a top view of an embodiment of the second detection element of the present invention.

FIG. 4A is a perspective view of an embodiment of the stationary unit of the present invention.

FIG. 4B is a top view of an embodiment of the stationary unit of the present invention.

FIG. 5A is a schematic view of an embodiment of the present invention showing the first detection electrodes and the second detection electrodes overlapped at an elevation difference.

FIG. 5B is a schematic view of another embodiment of the present invention showing the third detection electrodes and the fourth detection electrodes overlapped at an elevation difference.

FIG. 6A is a chart showing acceleration detection results on one axis according to the aforesaid embodiments.

FIG. 6B is a chart showing acceleration detection results on another one axis according to the aforesaid embodiments.

### DETAILED DESCRIPTION OF THE PREFERRED EMBODIMENTS

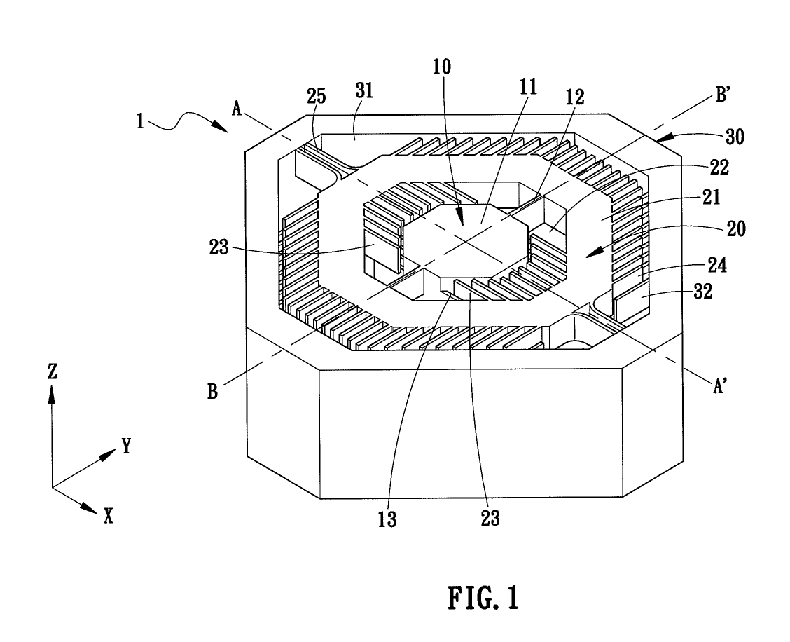

Please refer to FIG. 1 for an embodiment of the present invention. The dual-axis acceleration detection element 1 according to the present invention comprises a first detection element 10, a second detection element 20 and a stationary unit 30 that jointly form a detection platform. The first detection element 10 is movable (turnable) relative to the second detection element 20, and the second detection element 20 is movable (turnable) relative to the stationary unit 30, thereby can detect acceleration amount and direction on two different axes.

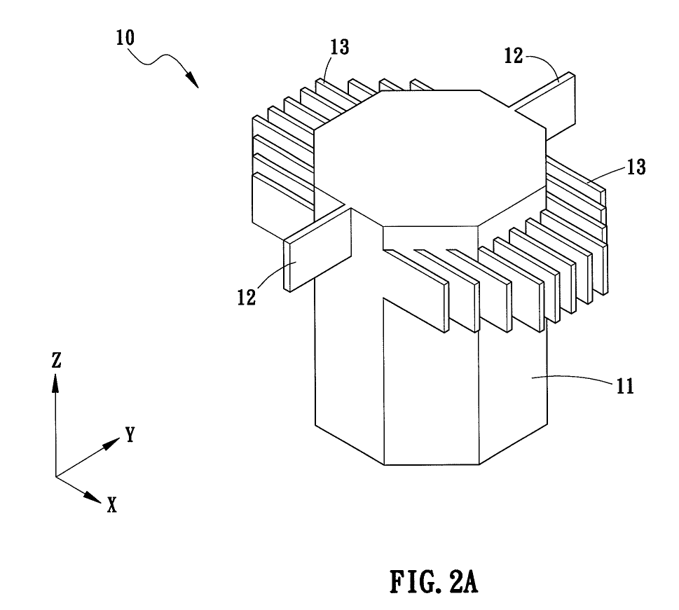

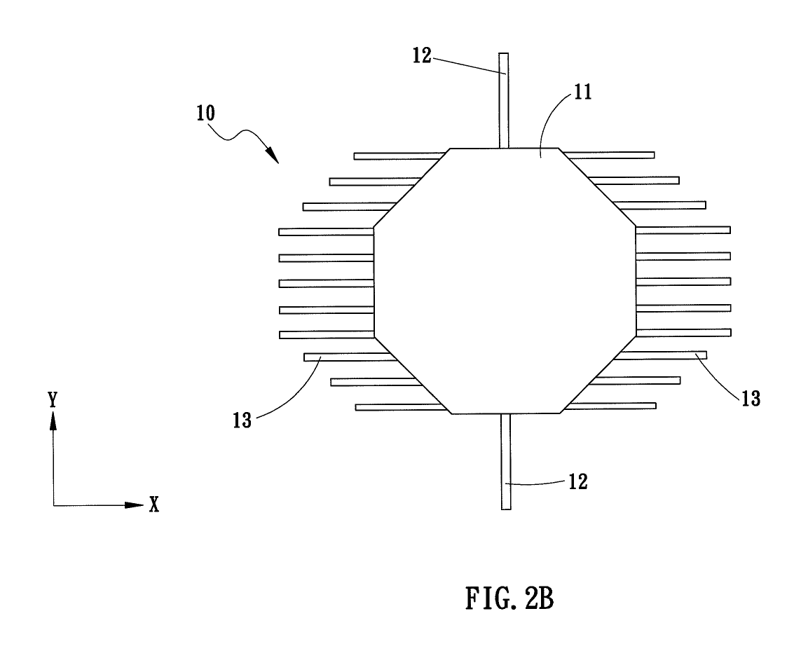

Refer to FIGS. 2A and 2B for an embodiment of the first detection element 10. The first detection element 10 includes a mass body 11 which contains a first axis 12 and a plurality of parallel first detection electrodes 13. The first axis 12 is connected to two opposite sides of the mass body 11 so that when the mass body 11 is subject to an external force and generates an inertia, it swings (twists/turns) about the first axis 12. The first detection electrodes 13 are arranged in parallel with each other and formed in a comb-shaped structure. In this embodiment, the first detection electrodes 13 are located at two opposite sides of the mass body 11 different from the axial direction of the first axis 12, such as perpendicular to each other shown in the drawings.

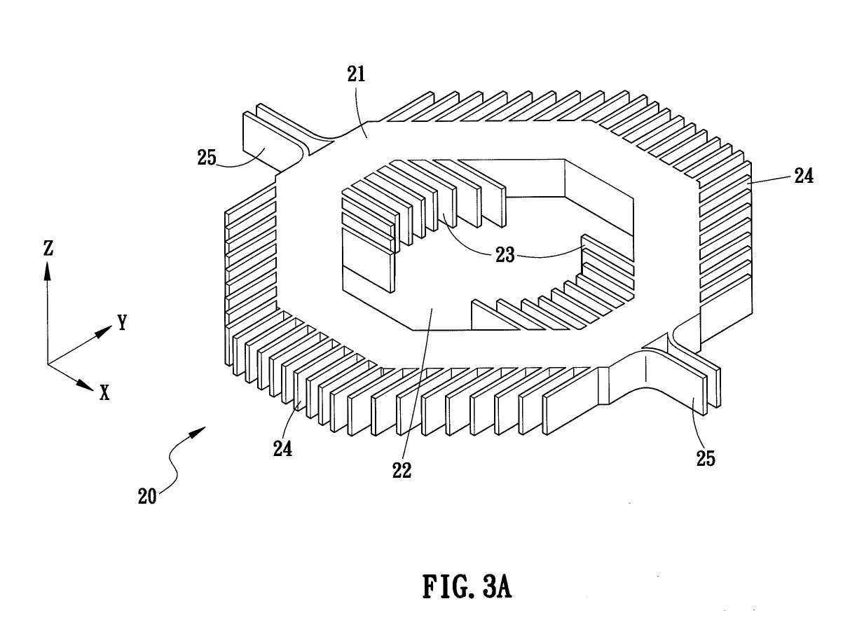

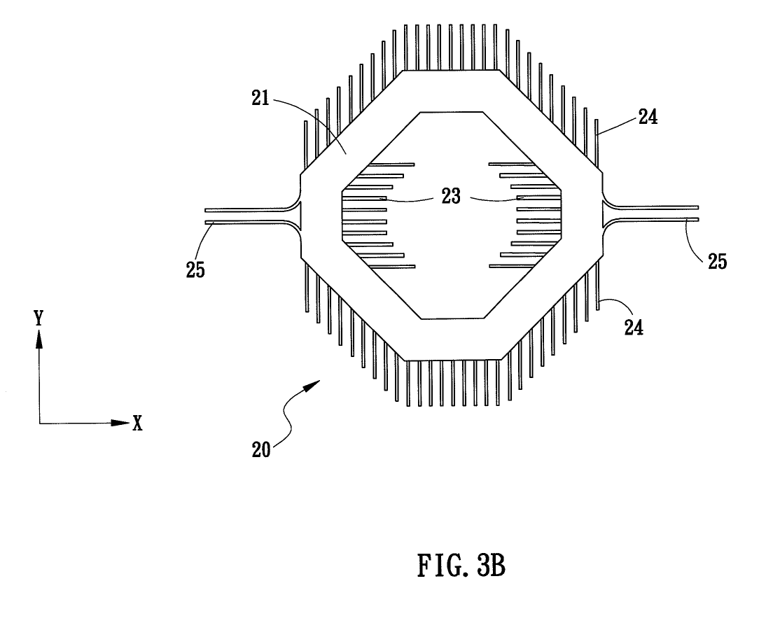

Refer to FIGS. 3A and 3B for an embodiment of the second detection element 20. The second detection element 20 includes an annular portion 21 which form a housing space 22 inside and a plurality of second detection electrodes 23 located on an inner side of the annular portion 21 corresponding to the first detection electrodes 13. The second detection electrodes 23 also are arranged in parallel with each other and formed in a comb-shaped structure. There are a plurality of third detection electrodes 24 on an outer side of the annular portion 21 that are also arranged in parallel with each other and formed in a comb-shaped structure. The annular portion 21 further includes a second axis 25. The annular portion 21 can swing (twist/turn) about the second axis 25. In this embodiment, the third detection electrodes 24 are located at two outer opposite sides of the annular portion 21 different from the axial direction of the second axis 25, such as perpendicular to each other shown in the drawings. The first axis 12 also is perpendicular to the second axis 25.

The first detection element 10 can be held in the housing space 22 and connected to the annular portion 21 through the first axis 12 as shown in FIG. 1, then the first detection electrodes 13 and the second detection electrodes 23 are overlapped and parallel with each other in a staggered manner to form an interdigitated arrangement to become a capacitive detection structure.

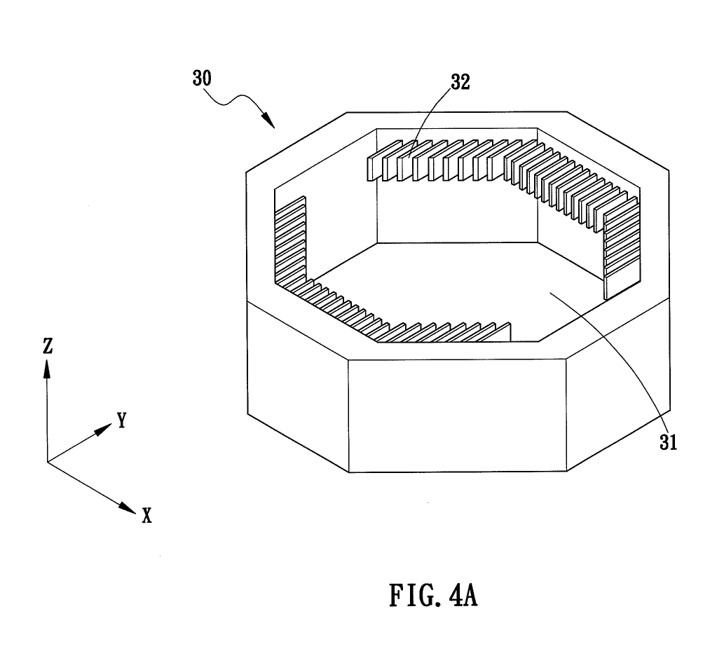

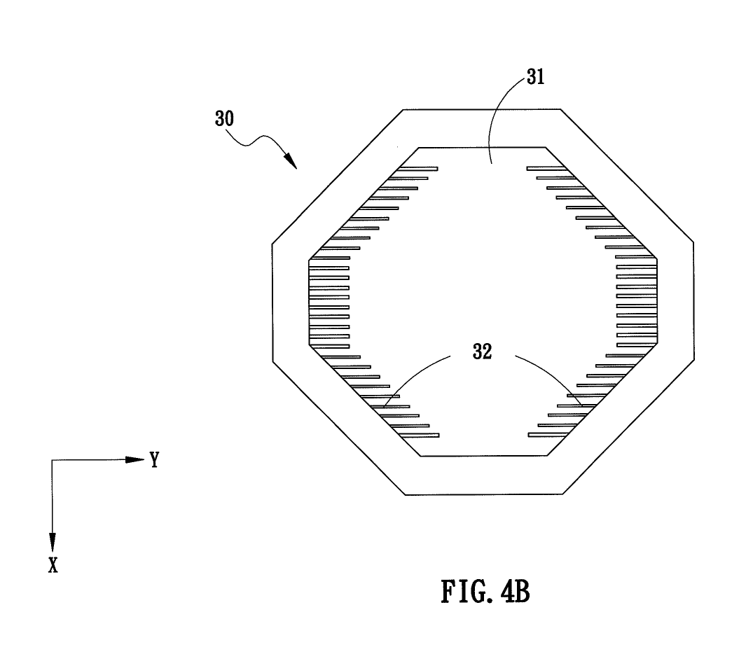

Refer to FIGS. 4A and 4B for an embodiment of the stationary unit 30. It includes a second housing space 31 inside and a plurality of fourth detection electrodes 32 located inside corresponding to the third detection electrodes 24. The fourth detection electrodes 32 are arranged in parallel with each other and formed in a comb-shaped structure. Also referring to FIG. 1, the second detection element 20 is held in the second housing space 31 and connected to the stationary unit 30 through the second axis 25, and the third detection electrodes 24 and the fourth detection electrodes 32 are overlapped and parallel with each other in a staggered manner to form an interdigitated arrangement to become another capacitive detection structure.

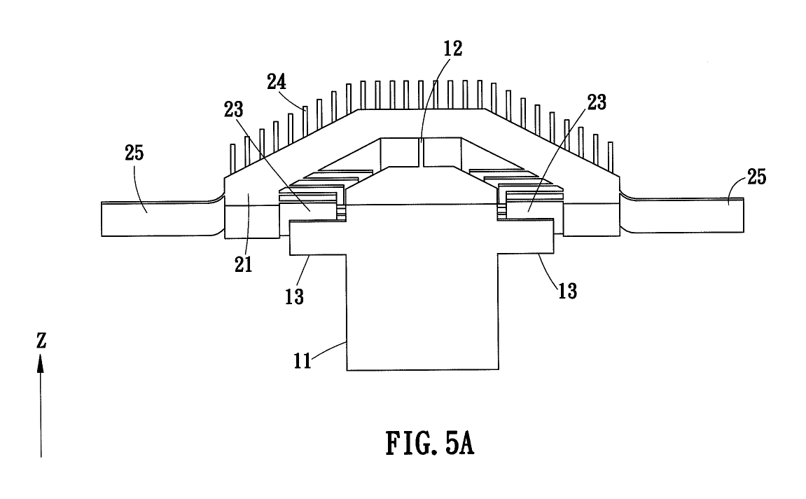

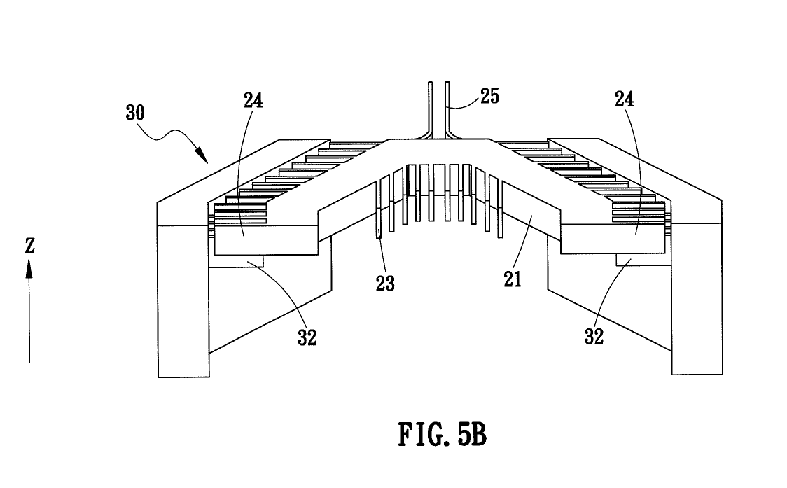

Referring to FIG. 1, in the embodiments set forth above, the first detection electrodes 13 are perpendicular to the first axis 12 (X axis shown in the drawing), and the third detection electrodes 24 are perpendicular to the second axis 25 (Y axis shown in the drawing), but this is not the limitation of the invention. Furthermore, the first detection electrodes 13, second detection electrodes 23, third detection electrodes 24 and/or fourth detection electrodes 32 can be high-aspect-ratio-micromachined (HARM) vertical-combs formed by a fabrication process including etching substrate, electroforming, electric discharge machining, trench-refill and the like. The first axis 12 and second axis 25 can be a gimbal spring. Referring to FIGS. 5A and 5B for the cross sections taken on lines AA′ and BB′ in FIG. 1, in another embodiment, the first detection electrodes 13 and second detection electrodes 23 are overlapped at an elevation difference in the direction of Z axis. The third detection electrodes 24 and fourth detection electrodes 32 also are overlapped at an elevation difference in the direction of Z axis.

When external forces are absent, the first detection element 10 is supported by the first axis 12 in a suspended manner and remains still relative to the second detection element 20; similarly, the second detection element 20 is supported by the second axis 25 in a suspended manner and remains still relative to the stationary unit 30. When the dual-axis acceleration detection element 1 of the present invention receives an acceleration on an X-Y plane, the mass body 11 outputs an inertial force and generates a torque through a pendulum structure, and transmits the force to the first axis 12 and second axis 25, hence the first axis 12 and/or second axis 25 are decoupled so that the mass body 11 outputs respectively a corresponding torque to the first axis 12 and second axis 25 to drive the detection platform swinging.

According to the capacitance equation C=∈A/d previously discussed, when two parallel electrode area changes, capacitance also alters. Hence when the first detection element 10 swings (twists) about the first axis 12, the first detection electrodes 13 at two sides of the first axis 12 corresponding to the second detection electrodes 23 generate area alterations and incur changes of capacitance values of +ΔC and −ΔC at two ends. Through output of capacitance difference at two sides, measurement by differential capacitance can be accomplished to detect acceleration parallel with direction of the second axis 25 (X axis). Similarly, when the second detection element 20 swings about the second axis 25, the acceleration parallel with direction of the first axis 12 (Y axis) also can be detected. It is to be noted that different accelerations cause the first detection element 10 or second detection element 20 to generate corresponding swing amounts, and different swing amounts correspond to different capacitances at the final detection, therefore can be used to detect the amount of acceleration.

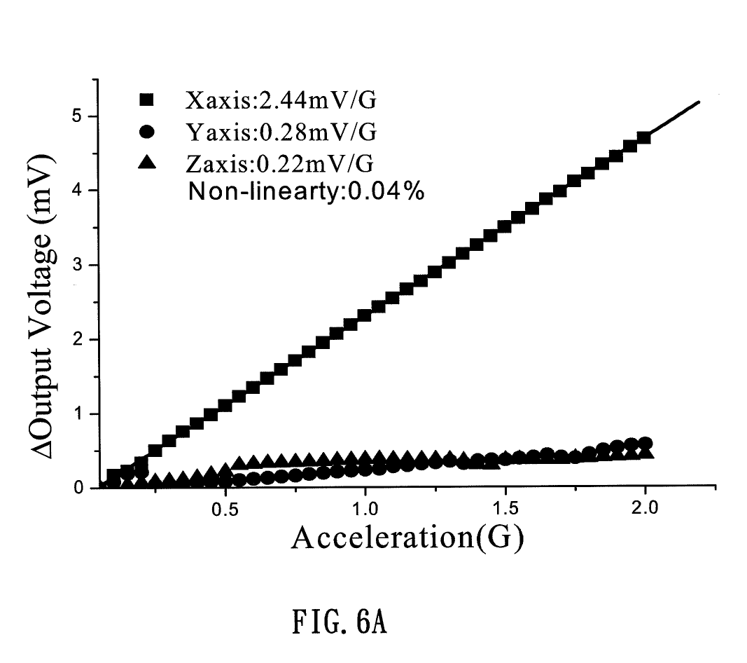

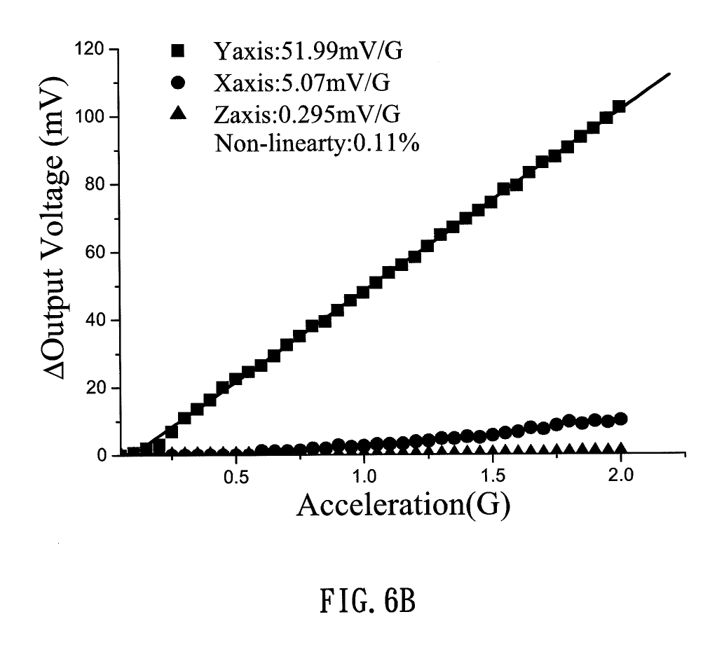

Refer to FIGS. 6A and 6B for the dual-axis acceleration detection results according to the aforesaid embodiments. Examples are provided to explain the advantages of the present invention in measurement. Through a commercial capacitive readout IC, a capacitance difference value generated by acceleration can be transformed to a voltage and output. The results show that the detected dual-axis acceleration is substantially in a linear relationship, and has a sensitivity of 2.44 mV/G and 51.99 mV/G relative to the X axis and Y axis. Moreover, cross-talk errors on the non-detection axis are very small.

It is to be noted that in the present invention the first detection element 10, second detection element 20 and stationary unit 30 are defined separately. Such a division merely aims to facilitate discussion. In practice, they can be independent and separated and assembled together, or be directly fabricated through micro-electromechanical or semiconductor manufacturing processes, such as etching, photolithography, refill and the like. These techniques are known in the art. For instance, the dual-axis acceleration detection element 1 of the invention can be made by adopting a MOSBE micro-electromechanical platform fabrication process. Reference of this platform technique can be found in “The Molded Surface-micromachining and Bulk Etching Release (MOSBE) Fabrication Platform on (111) Si for MOEMS┘ (Journal of Micromechanics and Microengineering, vol. 15, pp. 260-265” published in 2005. Details are omitted herein. Thus the detection electrodes and the first axis 12 and second axis 25 can be made through the technique of trench-refill with material of polycrystalline silicon. The mass body 11 can be formed by backside etching with material of silicon or the like. The acceleration detection element made through the micro-electromechanical fabrication process has many advantages, such as smaller size, lower cost and higher sensitivity.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A dual-axis acceleration detection element, comprising:
a first detection element including a mass body which includes a first axis and a plurality of first detection electrodes arranged in parallel with each other;
a second detection element which includes an annular portion to form a housing space and a plurality of parallel second detection electrodes located on an inner side of the annular portion and a plurality of parallel third detection electrodes on an outer side of the annular portion and a second axis; and
a stationary unit which includes a plurality of fourth detection electrodes;
wherein the first detection element is connected to the annular portion through the first axis such that the first detection electrodes and the second detection electrodes correspond to each other and are overlapped in a staggered manner; the second detection element being connected to the stationary unit through the second axis such that the third detection electrodes and the fourth detection electrodes correspond to each other and are overlapped in a staggered manner.

2. The dual-axis acceleration detection element of claim 1, wherein the first detection electrodes are located on two opposite sides of the mass body.

3. The dual-axis acceleration detection element of claim 1, wherein the third detection electrodes are located on two opposite sides of the annular portion.

4. The dual-axis acceleration detection element of claim 1, wherein the first detection electrodes are parallel with the second detection electrodes and the third detection electrodes are parallel with the fourth detection electrodes.

5. The dual-axis acceleration detection element of claim 4, wherein the first detection electrodes are perpendicular to the first axis, the third detection electrodes are perpendicular to the second axis, and the first axis is perpendicular to the second axis.

6. The dual-axis acceleration detection element of claim 1, wherein the first detection electrodes and the second detection electrodes are overlapped at varying elevations.

7. The dual-axis acceleration detection element of claim 1, wherein the third detection electrodes and the fourth detection electrodes are overlapped at varying elevations.

8. The dual-axis acceleration detection element of claim 1, wherein the first axis is a gimbal spring.

9. The dual-axis acceleration detection element of claim 1, wherein the second axis is a gimbal spring.

10. The dual-axis acceleration detection element of claim 1, wherein the acceleration element is a capacitive acceleration detection element.

11. The dual-axis acceleration detection element of claim 1, wherein the first detection electrodes, second detection electrodes, third detection electrodes and fourth detection electrodes are made from polycrystalline silicon.

12. The dual-axis acceleration detection element of claim 1, wherein the first axis and the second axis are made from polycrystalline silicon.

13. The dual-axis acceleration detection element of claim 1, wherein the mass body is made from silicon.
